(19) United States
(12) Patent Application Publication
(10) Pub. No.: US 2006/0081193 A1
(43) Pub. Date: Apr. 20, 2006

(54) Aquatect

(76) Inventor: David Owen Bennett JR., Hampstead, NH (US)

Correspondence Address: LGD DESIGN INNOVATIONS & SOLUTIONS, LLC, 525 MAIN STREET, HAMPSTEAD, NH, 03841, US

(21) Appl. No.: 11/163,382

(22) Filed: Oct. 17, 2005

Related U.S. Application Data
(60) Provisional application No. 60/522,592, filed on Oct. 18, 2004.

(51) Int. Cl. A01K 63/00

(52) U.S. Cl. 119/269

(57) ABSTRACT

Aquatect is an apparatus that consists of six building blocks that create a perfect, clean, and safe ecosystem for pets: herptiles (amphibians and reptiles), arthropods (spiders, insects, scorpions, and crustaceans), mollusks, and fish. The apparatus can be housed in aquarium tanks. The apparatus is constructed to replicate any ecosystem to accommodate any species listed above together or independently. The apparatus or blocks can also use different types of substrates to create various ecosystems. The ecosystem can be arid, tropical, humid, terrestrial, rocky, etc. to suit the needs of the species listed above. The ecosystem will be able to sustain life and suit the inhabitants. The apparatus or blocks are easily removable, and can be cleaned separately, so the ecosystem is not disturbed, or removed and cleaned all together. The blocks are not permanently adhered to the tank so they do not disrupt the integrity of the host tank. The apparatus is also unique because all the blocks work in union with each other and can be arranged in different configurations to create unique ecosystems. Aquatect gives a person total creativity to design a personal and unique ecosystem for their pet(s).

### BACKGROUND OF INVENTION

The general purpose of the invention (Aquatect) was the sole purpose of creating a unique design and apparatus that interacts with the builder and the pets that are housed in it. The apparatus is also unique in the fact it is not permanently attached to the tank. The invention or apparatus consists of six blocks that can either hold substrate or water. They can be used in different configurations to create a unique ecosystem tailored to its builder or inhabitants. The blocks have different uses, and setups are various. The apparatus is used in aquarium tanks. They are separate blocks that can be removed for easy maintenance, cleaning, or setup.

Aquatect was designed to be unique. There are no existing products that feature independent and easily accessible blocks. These blocks are all integrated as one complete apparatus supplying a safe and manageable ecosystem. The uniqueness of this design is that the blocks are not affixed to the tank they are hosting. The blocks can also be interchanged to suitably accommodate any animal or combination of animals such as but not limited to herptiles (amphibians and reptiles), arthropods (spiders, insects, scorpions, and crustaceans), mollusks, and fish. They can also be used with all or a combination of blocks to create and personalize the ecosystem. Aquatect gives a person total creativity to design a personal and unique ecosystem for their pet. The apparatus is easily removable, and can be cleaned separately, so the ecosystem is not disturbed, or removed and cleaned all together. Because they are not affixed to the tank they do not disrupt the integrity of the host tank. The blocks that hold substrate are also versatile to whatever material is needed for the inhabitants. The blocks will supply a habitant that will support both plants and animals. The apparatus is constructed to replicate any ecosystem to accommodate any species listed above. The apparatus is also unique because all the blocks work in conjunction with each other or separately to create a unique working ecosystem. Water circulates throughout the ecosystem keeping the ecosystem humid and supporting of plants and animals.

While the description and claims listed above describes the invention or apparatus, it must be known that the invention or apparatus may be subject to changes, modifications, or variation without departing from the original concept, scope, or design listed in the claims above. Any changes or modifications will be the sole property of LGD Design Innovations and must stay true to the accompanying claims.

### SUMMARY OF INVENTION

The invention was designed around the concept of six building blocks that create a perfect, clean, and safe ecosystem for pets. The Aquatect building apparatus or blocks are produced from a clear Polystyrene material. One of the base blocks A is used for holding substrate, plants, water, or accessories. A second base block B is also used for holding substrate, plants, water, or accessories. Both blocks A and B also create a land or water ecosystem for its inhabitants. The center block C is used for water or can be reversed and used as a platform or artificial land surface with substrate or not. An optional filter (not supplied) can be used with this block C to filter the water. Block C when used with a pump or filter (neither supplied) will pump water to blocks D and E to create a waterfall and supply a sub tank for fish or plants. There are two blocks D and E that can be attached to the side of the tank using suction cups that are supplied. The block D is fed from a filter (not supplied) from block C, which overflows water on two sides. The front side of D flows directly into the center base tank C to create a waterfall. The other side of block D overflows into the second block E to create a smaller waterfall. The second block E overflows into a smaller tank block F creating another waterfall. Block F fills with water and overflows into C creating a waterfall. Block F can house fish, snails, or water plants. The whole apparatus constantly filters the water and distributes the water in the form of overflowing waterfalls.

The apparatus can be used in different arrangements to create different effects. The blocks can also use different substrate to create different ecosystems. The blocks can be used together or separately to create a unique habitat for the builder. These ecosystems can be arid, tropical, humid, terrestrial, rocky, etc. The ecosystem will be able to sustain life and suit the inhabitants.

### BRIEF DESCRIPTION OF DRAWINGS

FIG. 1 is an exploded view of the Aquatect building blocks.

FIG. 2 is a perspective three-dimensional view of the Aquatect building blocks as placed in a tank outline in a standard orientation.

FIG. 3 Is a perspective view of the Aquatect building blocks in their standard orientation without the tank outline.

FIG. 4 is a view of block A, one of the six blocks that make up the embodiment of Aquatect and the present invention. FIG. 4 is a Front view, Top view, Side view, and a three-dimensional view of block A.

FIG. 5 is a view of block B, one of the six blocks that make up the embodiment of Aquatect and the present invention. FIG. 5 has a Front view, Top view, Rear view, and a three-dimensional view of block B.

FIG. 6 is a view of block C, one of the six blocks that make up the embodiment of Aquatect and the present invention. FIG. 6 has a Front view, Top view, Side view, and a three-dimensional view of block C.

FIG. 7 is a view of block E, one of the six blocks that make up the embodiment of Aquatect and the present invention. FIG. 7 has a Front view, Top view, Rear view, and a three-dimensional view of block E.

FIG. 8 is a view of block D, one of the six blocks that make up the embodiment of Aquatect and the present invention. FIG. 8 has a Front view, Top view, Side view, and a three-dimensional view of block D.

FIG. 9 is a view of block F, one of the six blocks that make up the embodiment of Aquatect and the present invention. FIG. 9 has a Side view, Top view, Rear view, and a three-dimensional view of block F.

### DETAILED DESCRIPTION OF PREFERRED EMBODIMENTS

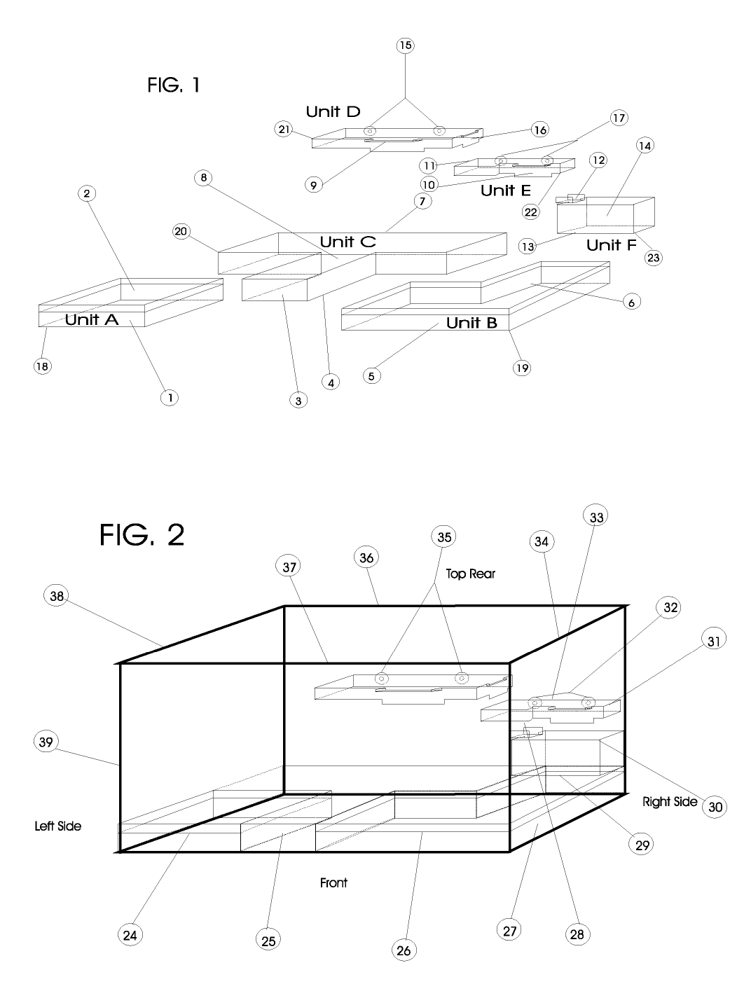

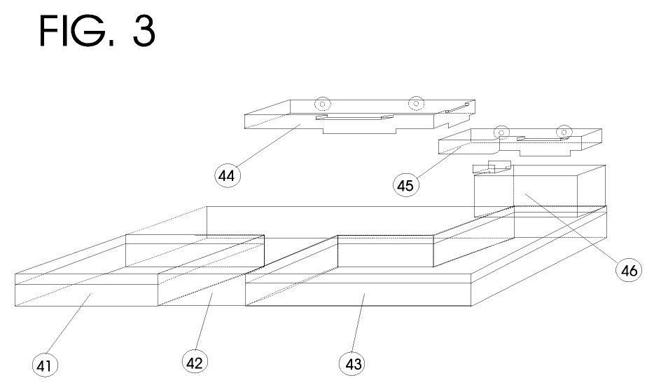

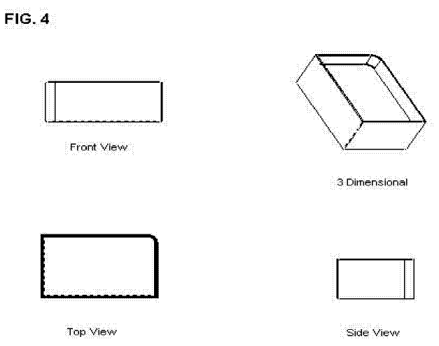

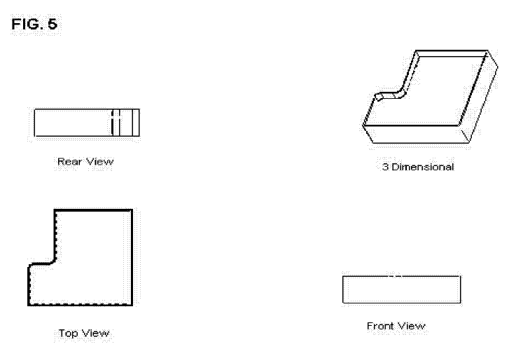

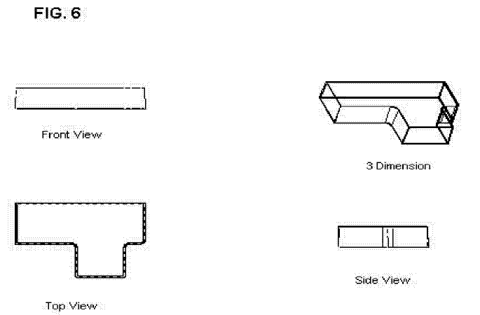

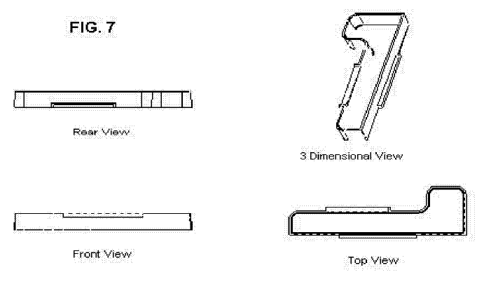

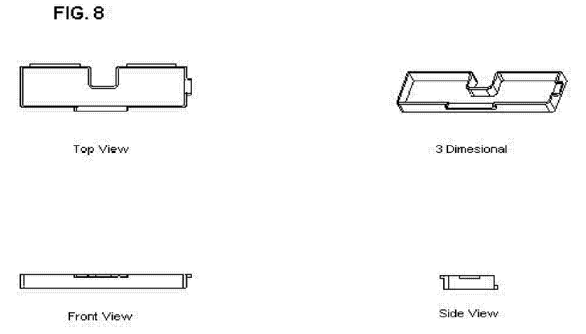

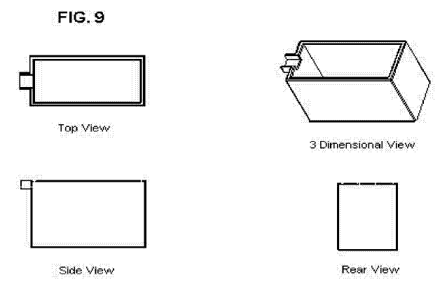

As illustrated in FIG. 1, is an exploded illustration similar to FIG. 2 and FIG. 3 illustrating the six building blocks or blocks according to the principles of the present invention. FIG. 1, balloon 1 is the front surface of block A. The base blocks A is used for holding substrate, plants, or accessories and it rests on the bottom of the aquarium tank. FIG. 1, balloon 2 is the top inside view of the base block A. The view shows block A in the standard configuration in which substrate or water is used for amphibians, turtles, crustaceans, reptiles, and other animals. FIG. 1, balloon 3 is the front view of the base block C. The view shows block C in the standard configuration in which substrate is us or water for amphibians, turtles, crustaceans, reptiles, and other animals. The water can be filtrated using a pump or filter not shown. FIG. 1, balloon 4 is the bottom surface of block C that rests on the bottom of the aquarium tank. FIG. 1, balloon 5 is the front view of the base block B the view shows block B in the standard configuration. FIG. 1, balloon 6 is the top inside view of the base block B. The view shows block B in the standard configuration in which substrate is used or water for amphibians, turtles, crustaceans, reptiles, and other animals. FIG. 1, balloon 7 is a rear view of block C where the filter block is placed inside. FIG. 1, balloon 8 is the top inside view of the base block C. The view shows block C in the standard configuration in which substrate is used or water for amphibians, turtles, crustaceans, reptiles, and other animals. FIG. 1, balloon 9 is the front view of the wall block D. The view shows block D in the standard configuration. This view shows the DIM. Where the water supplied by the filter used in view 7 is returned back into block C. FIG. 1, balloon 10 is the front view of the wall block E. The view shows block E in the standard configuration. This view shows the DIM. Where the water supplied by the filter used in view 7 is flowed into block E in a form of a waterfall-filling block F. FIG. 1, balloon 11 is a side view of block E where the water from block D flows into in a form of a waterfall-filling block E. FIG. 1, balloon 12 is a side view of block F where the water from block F flows into block C in a form of a waterfall re circulating the water. FIG. 1, balloon 13 is a view of block F seen from the front of the aquarium tank. FIG. 1, balloon 14 is an inside top view of block F used to house small aquatic fish, plants, and animals. FIG. 1, balloon 15 is a view of two suction cups used to secure block D to the side of an aquarium tank. These suction cups can be adjusted to the specific height requirement need for any application. FIG. 1, balloon 16 is a side view of block D where the water from block D flows into block E in a form of a waterfall-filling block E. FIG. 1, balloon 17 is a view of two suction cups used to secure block E to the side of an aquarium tank. These suction cups can be adjusted to the specific height requirement need for any application. FIG. 1, balloon 18 is the bottom surface of block A that rests on the bottom of the aquarium tank. FIG. 1, balloon 19 is the bottom surface of block B that rests on the bottom of the aquarium tank. FIG. 1, balloon 20 is a view of the side of block C that rests on the side of the aquarium tank. FIG. 1, balloon 21 is a view of the side of block D. FIG. 1, balloon 22 is a side view of block E. FIG. 1, balloon 23 is a side view of block F

As illustrated in FIG. 2, an actual representation of the principles of the present invention. FIG. 2 shows the six blocks or blocks housed in an aquarium tank. FIG. 2 also represents the standard configuration to the principles of the present invention. FIG. 2, balloon 24 is the front surface of block A. that rests in the front wall of the aquarium tank in the standard configuration. FIG. 2, balloon 25 is the front view of the base block C. The view shows block C in the standard configuration in which block C rests on the front wall of the aquarium tank interlocked between block A and block B. FIG. 2, balloon 26 is the front view of the base block B. The view shows block B in the standard configuration in which block B rests on the front wall of the aquarium tank. FIG. 2, balloon 27 is the side view of the base block B. The view shows block B in the standard configuration in which block B rests on the sidewall of the aquarium tank. FIG. 2, balloon 28 is the front view of the wall block E. The view shows block E in the standard configuration in which block E rests on the rear wall of the aquarium tank and over hangs. FIG. 2, balloon 29 is the bottom surface of block F that rests on the Top of block B. FIG. 2, balloon 30 is a view of the side of block F that rests on the side of the aquarium tank. FIG. 2, balloon 31 is a side view of block E that can rests on the side of the aquarium tank or be positioned by the suction cups to be adjusted to any specific height requirement need for any application. FIG. 2, balloon 32 is a view of block E secured to the rear of the aquarium tank using two suction cups. FIG. 2, balloon 33 is a view of the rear of block E. FIG. 2, balloon 34 is a view of the left side of an aquarium tank that would house or support the blocks. FIG. 2, balloon 35 is a rear view of block D that is supported the aquarium tank by the suction cups that can be adjusted to any specific height requirement need for any application. FIG. 2, balloon 36 is a view of the rear side of an aquarium tank that would house or support the blocks. FIG. 2, balloon 37 is a view of the front side of an aquarium tank that would house or support the blocks. FIG. 2, balloon 38 is a view of the right side of an aquarium tank that would house or support the blocks. FIG. 2, balloon 39 is a view of an aquarium tank that is represented by a solid black line outlining a representation the standard configuration to the principles of the present invention.

As illustrated in FIG. 3 is an illustration similar to FIG. 2 representing the standard configuration of the present invention without representing the aquarium outline. FIG. 3, balloon 41 is the front surface of block A. The right and rear sides rest against block C. The right side and front rest against the aquarium tank walls. The bottom of block A rests on the floor of the aquarium. FIG. 3, balloon 42 is the front view of the base block C. The right side rests against the left side of block B. The rear rests against the back of the aquarium tank. The left side rests against the left side of the tank and block A. The bottom of block C rests on the floor of the aquarium. FIG. 3, balloon 43 is the front view of the base block B the view shows block B in the standard configuration. The right side of block B rests against the right side of the aquarium. The rear side rests against the rear of the aquarium. The left side of block B rests against the right side of block C. The bottom of block C rests on the floor of the aquarium. FIG. 3, balloon 44 is the front view of the wall block D. The view shows block D in the standard configuration. The right side of block B faces the right side of the aquarium. The rear side rests against the rear of the aquarium. The left side of block B faces against the left side of aquarium tank. The bottom of block D is suspended in air and does not come in contact with any surface. Block D can be placed on any wall surface in the tank using two suction cups. FIG. 3, balloon 45 is the front view of the wall block E. The view shows block E in the standard configuration. The right side of block E faces the right side of the aquarium. The rear side rests against the rear of the aquarium. The left side of block E faces against the left side of aquarium tank. The bottom of block E is suspended in air and does not come in contact with any surface. Block E can be placed on any wall surface in the tank using two suction cups. FIG. 3, balloon 46 is the front view of the tank block F. The view shows block F in the standard configuration. The right side of block F faces the right side of the aquarium. The rear side rests against the rear of the aquarium. The left side of block F faces against the left side block C. The bottom of block F is seated on block B.

What is claimed is:

1. The apparatus named Aquatect wherein consists of six building blocks that creates a perfect, clean, and safe ecosystem for pets herptiles (amphibians and reptiles), arthropods (spiders, insects, scorpions, and crustaceans), mollusks, and fish.

2. The apparatus can be housed in aquarium tanks.

3. The apparatus is not permanently fixed to the tank making it easily removable to be cleaned separately, so they do not disrupt the integrity of the host tank.

4. The apparatus as defined wherein all the blocks are interchangeable with multiple roles for substrate and water applications.

5. The apparatus as defined, wherein block C can be used with an optional filter (not supplied) to filter the water through blocks D, E, F, creating waterfalls and circulation of water supply for aeration and humidity.

6. The apparatus as defined, wherein Block D and E can be attached to the side of the tank using suction cups that are supplied.

7. The apparatus as defined, wherein Block D and E can be used as defined wherein with an optional filter supplying water to form a waterfall.

8. The apparatus as defined, wherein Block F is filled with water and overflows into block C to create a waterfall and complete the circulation of water.

9. The apparatus as defined, wherein all six blocks are produced using a clear Polystyrene material.

10. The apparatus named Aquatect gives a person total creativity to design a personal and unique ecosystem for their pet.
